(19) United States
(12) Patent Application Publication
(10) Pub. No.: US 2013/0191248 A1
(43) Pub. Date: Jul. 25, 2013

(54) METHOD AND SYSTEM FOR PROVIDING SECURE LOAN-BASED TRANSACTIONS

(71) Applicant: Jessica L. Snow, Mountain View, CA (US)

(72) Inventor: Jessica L. Snow, Mountain View, CA (US)

(21) Appl. No.: 13/356,068

(22) Filed: Jan. 23, 2012

(51) Int. Cl. G06Q 30/06

(52) U.S. Cl. 705/26.41

(57) ABSTRACT

A loan is made to a borrower such that the loan funds remain in an account associated with the borrower and cannot be directly accessed by the borrower as cash/currency. The borrower then submits a purchase request indicating items the borrower desires to purchase via a secure loan-based transaction using the approved loan funds. The borrower's purchase request is analyzed and, if the requested purchase is deemed appropriate, the purchase is approved. The funds required to make the approved purchase are then transferred from the borrower's loan account to designated/approved merchant(s) directly, without the transfer of cash to the borrower. The borrower is then informed of the completed financial transaction and the requested purchase items are obtained by, and/or delivered to, the borrower.

### BACKGROUND

For most potential small business owners, the ability to obtain a business loan literally determines whether a new business can be embarked upon or not. However, securing a small business loan is often extremely difficult, particularly in difficult economic times. This is partly because small business loans are typically unsecured loans, i.e., are not backed up by any, or sufficient, collateral, and are therefore made based almost solely on the financial reputation of the borrower. In addition, currently, most small business loans, once made, represent a transfer of cash resources to a small business owner/manager who can then choose to use the cash in any manner they see fit. As a result, once a lending institution has made a small business loan they typically lose control over how the funds lent are used. Clearly this is not considered an ideal situation by risk adverse banks and other lending institutions.

In addition, in many parts of the world, and particularly in areas having developing/emerging economies, not only is there often little or no collateral available to back up small business loans, but, in addition, there is little or no computing system implemented financial management and tracking infrastructure, such as banks, electronic accounts, credit cards, or debit cards. In fact, in these areas there is often little, or no, network or computing system infrastructure at all. Consequently, currently, these developing/emerging economies are often currency based economies where virtually all transactions are conducted using cash, or the promise of cash.

Unfortunately, cash can present significant problems for both the business owner/borrower and lender. First off, cash can be lost, stolen, and/or otherwise misappropriated very easily, thereby leaving the new business without funds to continue operating, or with any hope, or way, of paying back the loan. In addition, in many developing/emerging economies there are few mechanisms in place to protect a business owner from unscrupulous merchants and/or other “middlemen”. As a result, cash can be readily misappropriated with little or no recourse; thereby again leaving the business without funds, or anyway of paying back the loan.

In addition, in some cases, and particularly in cases where the borrower is a woman living in a male dominated culture, cash provided to a borrower, such as a woman, as seed money for a new business venture can be taken away from the borrower by a spouse, or other relative. In many cases, the loan money is taken away from the borrower by force and then used by the spouse/relative for various unintended purposes such as gambling, prostitution, and/or the purchase of drugs/alcohol. This type of activity has been observed/documented in many areas and is particularly prevalent in cases involving “microcredit” and “microloans”.

Microcredit is the extension of very small loans (microloans) to those in poverty in an effort to spur entrepreneurship. As noted above, the borrowers receiving microloans typically lack collateral, steady employment, or any verifiable credit history. Therefore, these individuals typically cannot meet even the most minimal qualifications to gain access to traditional credit. Microcredit is a part of microfinance, which is the provision of a wider range of financial services to the very poor.

Due to the historical success of microcredit systems, many in the traditional banking industry have begun to realize that these microcredit borrowers should more correctly be categorized as “pre-bankable”; thus, microcredit is gaining credibility in the mainstream finance industry. As a result, many traditional large finance organizations are contemplating microcredit projects as a source of future growth, even though almost everyone in larger development organizations discounted the likelihood of success of microcredit when it was begun.

Lending to women has become an important principle in microcredit, with some banks and other lending institutions catering to women almost exclusively.

Indeed, women presently make up ninety-five percent of some bank's clients and women continue to make up seventy-five percent of all microcredit recipients worldwide. This is due largely to the fact that historically women have higher repayment rates, and women tend to accept smaller loans.

Thus far, microcredit has proven to be a powerful tool for socioeconomic development in many regions of the world. However, the number of loan defaults due to the microloan money being taken away/stolen from the borrower by unscrupulous parties such as merchants, and/or other “middlemen parties, spouses, relatives, etc., threatens this highly effective and humanitarian system. As noted above, a major source of the problem is the fact that the microloans are currently made in cash, and cash can be misappropriated far too easily, often with little or no recourse for the borrower against the thief.

As a result of the current situation described above, where the lending institutions forfeit all control of the loan funds they provide, and the loan funds are provided as cash and are therefore subject to theft and misappropriation, it is often quite difficult for potential small business owners to obtain loans, and many desperately needed business loans are currently being denied as being too risky. This is unfortunate for all parties involved and is particularly unfortunate in the case of microloans where a relatively small investment can yield extremely positive results that can change the lives of some of the world's poorest people for the better and, in some cases, even save lives.

What is needed is a method and system for providing secure loan-based transactions that provides the lender some control over how the loan funds are spent and ensures that the loan funds remain the property of the borrower and are not subject to theft or other misappropriation.

### SUMMARY

In accordance with one embodiment, a method and system for providing secure loan-based transactions includes a process for providing secure loan-based transactions whereby, in one embodiment, a loan is made to a borrower such that the loan funds remain in an account associated with the borrower and cannot be directly accessed by the borrower as cash/currency. In one embodiment, the borrower submits a purchase request to the loan program provider indicating items the borrower desires to purchase via a secure loan-based transaction using the approved loan funds. In one embodiment, the borrower's purchase request is analyzed to determine one or more of, but not limited to, the type and/or suitability of the items the borrower desires to purchase, the estimated or actual cost of the items the borrower desires purchase, the balance of funds in the borrower's loan account, the merchant, or merchants, from which the items will be purchased and/or the suitability/reputation of the merchant(s), and/or any other purchase request information/data desired and/or available. In one embodiment, if the requested purchase is deemed appropriate, the purchase is approved. In one embodiment, the funds required to make the approved purchase are then transferred from the borrower's loan account to the designated/approved merchant(s) directly, without the transfer of cash to the borrower. In one embodiment, the borrower is then informed of the completed, or intended, financial transaction, i.e., the transfer of funds, and where and when the requested purchase items are to be obtained by, and/or delivered to, the borrower.

Using the method and system for providing secure loan-based transactions discussed herein, a borrower can only use loan funds for purchases approved by the loan program provider. As a result, the lender is provided input to, and some control over, how the loan funds are used. In addition, using the method and system for providing secure loan-based transactions discussed herein, the borrower is never provided cash, or direct access to cash, and in one embodiment, the borrow's identification is confirm one or more times in the process, consequently, the loan funds are relatively protected from loss, theft, or other misappropriation; even theft/misappropriation by a spouse or family member. Consequently, using the method and system for providing secure loan-based transactions discussed herein, even loans made in the absence of collateral are more likely to be paid back. As a result, more loans will be made and more potential business owners will be provided the opportunity to succeed. In addition, when the method and system for providing secure loan-based transactions discussed herein is applied to microcredit/microloan systems, and more of these loans are made, the lives of the some of the world's poorest individuals will be dramatically improved, and in some cases literally saved.

### BRIEF DESCRIPTION OF THE DRAWINGS

FIG. 1 is a block diagram of an exemplary hardware architecture for implementing one embodiment; and

FIG. 2 is a flow chart depicting a process for providing secure loan-based transactions in accordance with one embodiment.

Common reference numerals are used throughout the FIGS. and the detailed description to indicate like elements. One skilled in the art will readily recognize that the above FIGS. are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be embodied in many different forms and should not be construed as limited to the embodiments set forth herein, shown in the FIGS., and/or described below. Rather, these exemplary embodiments are provided to allow a complete disclosure that conveys the principles of the invention, as set forth in the claims, to those of skill in the art.

In accordance with one embodiment, a method and system for providing secure loan-based transactions includes a process for providing secure loan-based transactions whereby, in one embodiment, a secure transaction business loan program is provided.

In various embodiments, the secure transaction business loan program is provided by one or more of, but not limited to, private banks, financial institutions, lending agencies, government agencies, international agencies, charities, and/or other public and private parties.

In various embodiments, the secure transaction business loan program is implemented using, and/or is intended for use with, traditional computing system architectures and infrastructure.

Herein, the term “computing system” includes, but is not limited to, any computing system known in the art at the time of filing, and/or as developed after the time of filing, such as, but not limited to: a mobile computing system; a desktop computing system; a laptop computing system; a notebook computing system; a workstation; a two-way pager; a cellular telephone; a smart phone; a digital wireless telephone; a Personal Digital Assistant (PDA); a server computer; an Internet appliance, any other device, or any desired combination of these devices, that includes components that can execute all, or part, of a process for providing secure loan-based transactions in accordance with at least one of the embodiments as discussed herein, and/or as known in the art at the time of filing, and/or as developed after the time of filing.

In various embodiments, the secure transaction business loan program is implemented using, and/or is intended for use with, other communications systems and infrastructure, such as, but not limited to, mobile communication systems.

Herein, the term “mobile computing system” includes, but not limited to: a mobile phone; a smart phone; an internet appliance; any Short Message Service (SMS) capable system; or any other mobile computing system as discussed herein, and/or as known in the art at the time of filing, and/or as developed after the time of filing capable of receiving SMS message traffic.

In various embodiments, the secure transaction business loan program is implemented using an SMS communication infrastructure capable of being accessed and used through mobile computing systems, such as mobile phones, which are far more common and accessible in many parts of the world than traditional computing systems and Internet access. Consequently, one embodiment of the method and system for providing secure loan-based transactions discussed herein can be utilized even in parts of the world where traditional Internet access is not available.

In one embodiment, the secure transaction business loan program provides secure transaction business loans and loan accounts to approved borrowers such that the approved loan funds remain in an account associated with the borrower and cannot be directly accessed by the borrower as cash/currency.

In one embodiment, the secure transaction business loan program is particularly directed to making secure transaction business loans to borrowers who do not qualify for more traditional business loans.

In various embodiments, the secure transaction business loan program is particularly directed to operating in a microcredit environment and providing secure transaction microloans.

In various embodiments, the secure transaction business loan program is particularly directed to making secure transaction business loans to borrowers in designated areas, such as areas having developing/emerging economies.

As discussed in more detail below, in some embodiments, the secure transaction business loan program includes, determines, and/or is associated with, one or more databases that include data identifying approved products and/or services that are considered appropriate for purchase using secure transaction business loan funds.

As also discussed in more detail below, in some embodiments, the secure transaction business loan program includes, sponsors, and/or is associated with, one or more networks of approved merchants and/or providers of products and services.

As also discussed in more detail below, in some embodiments, the secure transaction business loan program includes, determines, and/or is associated with, one or more databases including data for determining the relative real-time market price of various approved products and services.

In one embodiment, a potential borrower applies for a secure transaction business loan through the secure transaction business loan program. In various embodiments, as part of the application process, the potential borrower provides various loan application/request information/data.

In various embodiments, the loan application/request information/data includes, but is not limited to, information/data indicating one or more of: identification and other personal information associated with the borrower, and/or the borrower's financial situation, such as, but not limited to, the borrower's name, identification numbers associated with the borrower, the borrower's address, any credit history or financial accounts associated with the borrower, etc.; the type of business the borrower intends to finance with the secure transaction business loan; the specific purpose of the secure transaction business loan, e.g., for purchasing inventory, for obtaining business space, for obtaining employees, etc.; the requested amount of the secure transaction business loan; the anticipated, or estimated, products and/or services to be purchased using the secure transaction business loan; and/or any other loan application/request information/data desired/required by the provider of the secure transaction business loan program.

In one embodiment, the loan application/request information/data is provided by the potential borrower in person, or in written/printed form. In one embodiment, the loan application/request information/data is provided by the potential borrower via one or more computing systems and the Internet. In one embodiment, the loan application/request is provided by the borrower via a mobile computing system, and/or one or more mobile applications, and/or one or more mobile communication systems, such as SMS.

In one embodiment, the loan application/request information/data is authenticated/verified to ensure the borrower's identity is legitimate and to verify any, or all, of the loan application/request information/data. In various embodiments, the loan application/request information/data is authenticated/verified using any mechanism, means, process, and/or procedure as discussed herein, and/or as known in the art at the time of filing, and/or as developed/made available after the time of filing.

In one embodiment, the loan application/request information/data is reviewed/analyzed by the provider of the secure transaction business loan program and a decision is made to either approve, or disapprove, the requested secure transaction business loan.

As noted above, in some embodiments, the secure transaction business loan program is particularly directed to providing secure transaction business loans to borrowers who would not qualify for traditional loans due to one or more perceived financial disadvantages such as lack of collateral, steady employment, or any verifiable credit history. Consequently, in some embodiments, the decision to either approve, or disapprove, the requested secure transaction business loan is not made primarily on traditional financial analysis. Instead, in various embodiments, the decision to either approve, or disapprove, the requested secure transaction business loan is made based primarily on the type of business to be funded by the secure transaction business loan, the products and or services to be provided by the business to be funded by the secure transaction business loan, and the perceived contribution to the community by the business to be funded by the secure transaction loan.

In one embodiment, once the requested secure transaction business loan is conditionally approved. In one embodiment, once the requested secure transaction business loan is conditionally approved, the borrower is informed of the approval and the conditions of approval, including the operational rules for using the secure transaction business loan.

In various embodiments, the borrower is informed of the approved amount of the secure transaction business loan along with information/data indicating one or more of, but not limited to, the following: the terms of the secure transaction business loan, including repayment plans, interest, and any other charges/responsibilities to be imposed upon the borrower; the specific purpose of the secure transaction business loan, i.e., what business the secure transaction business loan is intended to fund; what products the secure transaction business loan is intended to fund, including, in one embodiment, data indicating what products and/or services are considered appropriate for purchase using the secure transaction business loan funds; what merchants, if any, are approved to provide the products and/or services to the borrower, including, in one embodiment, data indicating merchants who are in a pre-approved merchant network associated with the secure transaction business loan program; how to submit a purchase request to use the secure transaction business loan funds; and/or any other information the provider of the secure transaction business loan program, and/or lender, desires to provide the borrower at the time the secure transaction business loan is approved.

In one embodiment, the borrower is informed of the approved amount of the secure transaction business loan along with approval information/data by written correspondence. In one embodiment, the borrower is informed of the approved amount of the secure transaction business loan along with approval information/data via one or more computing systems and the Internet. In one embodiment, the borrower is informed of the approved amount of the secure transaction business loan along with approval information/data via a mobile computing system, and/or one or more mobile applications, and/or one or more mobile communication systems, such as SMS.

In one embodiment, the borrower accepts the approved secure transaction business loan and indicates agreement to the terms of the approved secure transaction business loan. In one embodiment, the borrower accepts the approved secure transaction business loan and indicates agreement to the terms of the approved secure transaction business loan by written correspondence. In one embodiment, the borrower accepts the approved secure transaction business loan and indicates agreement to the terms of the approved secure transaction business loan via one or more computing systems and the Internet. In one embodiment, borrower accepts the approved secure transaction business loan and indicates agreement to the terms of the approved secure transaction business loan via a mobile computing system, and/or one or more mobile applications, and/or one or more mobile communication systems, such as SMS.

In one embodiment, upon receipt of the borrower's acceptance of the approved secure transaction business loan and indication of agreement to the terms of the approved secure transaction business loan, a secure transaction business loan account is established and/or associated with the borrower and the approved secure transaction business loan funds are transferred to the borrower's secure transaction business loan account. However, according to various embodiments, neither the borrower, nor any party other than an approved merchant, is provided direct access to secure transaction business loan funds. Therefore, only approved merchants receive cash from the secure transaction business loan account. As a result, using the process for providing secure loan-based transactions, the provider of the secure transaction business loan, and/or lender, retains some control over how the secure transaction business loan funds are spent. In addition, using the process for providing secure loan-based transactions, there is no opportunity for family members, or any other parties, to steal/misappropriate the secure transaction business loan funds.

In one embodiment, when the borrower determines one or more products and/or services they need to purchase using the secure transaction business loan funds, the borrower submits a purchase request to the secure transaction business loan program provider. In various embodiments, the purchase request includes, but not is not limited to, information/data indicating: the products and/or services the borrower desires to purchase; the number/amount of products and/or services the borrower desires to purchase; the estimated, or known, cost of the products and/or services the borrower desires to purchase, or, in one embodiment, a request for the estimated, or known, cost of the products and/or services the borrower desires to purchase; a request for a listing indicating pre-approved merchants, or “in-network” merchants associated with the products and/or services the borrower desires to purchase; the name, and/or location, of a given merchant from which the borrower desires to purchase the products and/or services; a date, or date range, the borrower desires to purchase, and/or obtain, the desired products and/or services; a time of day the borrower desires to purchase, and/or obtain, the desired products and/or services; the location where the borrower desires to pick up, or take delivery of, the desired products and/or services once purchased; and/or any other purchase request information desired by the secure transaction business loan program provider, and/or one or more merchants, and/or the borrower.

In one embodiment, the purchase request information/data is provided by the potential borrower in person, or in written/printed form. In one embodiment, the loan purchase request information/data is provided by the potential borrower via one or more computing systems and the Internet. In one embodiment, the purchase request information/data is provided by the borrower via a mobile computing system, and/or one or more mobile applications, and/or one or more mobile communication systems, such as SMS.

In one embodiment, the borrower's purchase request is analyzed by the secure transaction business loan program provider to determine one or more of, but not limited to: the type and/or suitability of the products and/or services the borrower desires to purchase; the stated, estimated, or determined, cost of the products and/or services the borrower desires purchase; the balance of funds in the borrower's secure transaction business loan account; the merchant, or merchants, from which the items will be purchased and/or the suitability of the merchant(s), and/or whether any specifically requested merchant is in the network of pre-approved merchants; and/or any other information/data in the purchase request.

In one embodiment, the borrower's purchase request is approved by the secure transaction business loan program provider. In one embodiment, the borrower's identity is again verified before any funds are released.

In various embodiments, in response to the borrower's purchase request, along with the approval notification, the secure transaction business loan program provider provides the borrower with one or more of the following approved loan information/data: information/data representing a listing of pre-approved, or in network, merchants capable of providing the products and/or services that are the subject of the purchase request; information/data indicating the actual, or estimated, market price for the products and/or services that are the subject of the purchase request, as calculated/obtained by the secure transaction business loan program provider; information/data indicating a projected balance of funds in the borrower's secure transaction business loan account that will remain after the purchase of the products and/or services; information/data indicating a list of approved products and/or services that is a subset of the products and/or services that are the subject of the purchase request; or any other data/information deemed to potentially be of interest to the borrower.

In one embodiment, the approval and/or approved loan information/data is provided to the borrower in person, or in written/printed form. In one embodiment, the approval and/or approved loan information/data is provided to the borrower via one or more computing systems and the Internet. In one embodiment, the approval and/or approved loan information/data is provided to the borrower via a mobile computing system, and/or one or more mobile applications, and/or one or more mobile communication systems, such as SMS.

In one embodiment, the products and/or services that are the subject of the approved purchase request are presented to two or more merchants in the approved merchant network who can provide the approved products and/or services. In one embodiment, the two or more merchants are provided the opportunity to bid for the business, thereby potentially providing the borrower with a better price.

In one embodiment, once a merchant is designated/approved to provide the products and/or services associated with the approved purchase request, the provider of the secure transaction business loan program either transfers, or arranges for the future transfer of, the required funds to purchase the approved products and/or services from borrower's secure transaction business loan account directly to the designated/approved merchant, i.e., without providing the funds directly to the borrower. Consequently, neither the borrower, nor any party other than the designated/approved merchant, is provided direct access to secure transaction business loan funds. Therefore, only the designated/approved merchant can receive cash from the secure transaction business loan account. As a result, using the process for providing secure loan-based transactions, the provider of the secure transaction business loan retains some control over how the secure transaction business loan funds are spent. In addition, using the process for providing secure loan-based transactions, there is no opportunity for family members, or any other parties, to steal/misappropriate the secure transaction business loan funds.

In one embodiment, the borrower is then informed of the completed financial transaction, or the pending financial transaction. In one embodiment, the borrower is also provided pickup and/or delivery information/data indicating where and how the borrower can physically obtain the approved products and/or services associated with the approved purchase request.

In one embodiment, the completed financial transaction, and/or delivery/pick up information/data, is provided to the borrower in person, or in written/printed form. In one embodiment, the completed financial transaction, and/or delivery/pick up information/data, is provided to the borrower via one or more computing systems and the Internet. In one embodiment, the completed financial transaction, and/or delivery/pick up information/data, is provided to the borrower via a mobile computing system, and/or one or more mobile applications, and/or one or more mobile communication systems, such as SMS.

In one embodiment, the borrower obtains, or takes delivery of the approved, and paid for, products and/or services according to the terms of the approved loan information/data. In one embodiment, the borrower's identity is again verified before any products are released.

In one embodiment, the borrower is provided the opportunity to submit feedback to the provider of the secure transaction business loan program regarding the secure transaction business loan program, the products and/or services obtained, and/or the merchant(s) providing the products and/or services. In various embodiments, this ensures that the secure transaction business loan program is self-learning and that the merchants in the approved merchant network are performing to the standards set by the provider of the secure transaction business loan program.

In one embodiment, the borrower provides the feedback information/data in person, or in written/printed form. In one embodiment, the borrower provides the feedback information/data via one or more computing systems and the Internet. In one embodiment, the borrower provides the feedback information/data via a mobile computing system, and/or one or more mobile applications, and/or one or more mobile communication systems, such as SMS.

### Hardware System Architecture

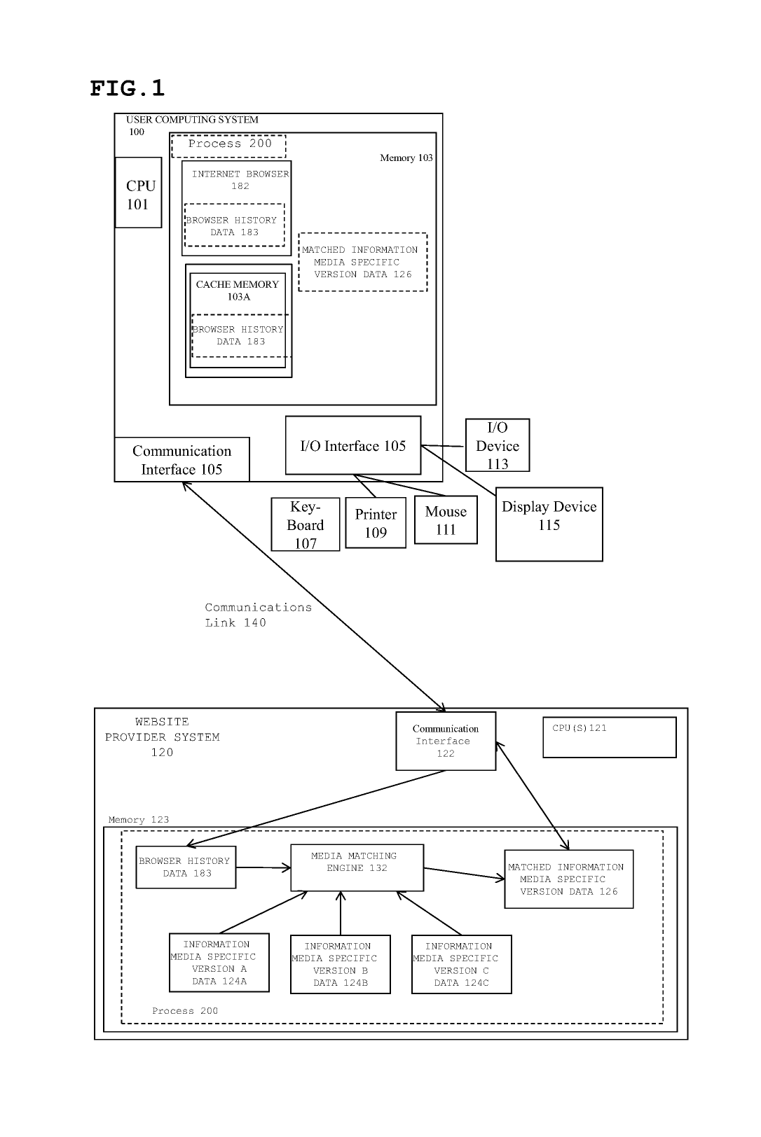

FIG. 1 is a block diagram of an exemplary hardware architecture for implementing one embodiment of a system and method for providing secure loan-based transactions, such as exemplary process 200, discussed herein, that includes: a borrower computing system 100, e.g., a computing system such as a mobile phone associated with/accessible by, a borrower; a merchant computing system 150, e.g., a computing system such as a mobile phone associated with/accessible by, a merchant; a loan program provider system 120, e.g., a computing system associated with, or accessible by, a provider of a secure transaction business loan program; a database 170, e.g., an approved merchant and/or approved products database; a communications link 140A, e.g., a first communications link; a communications link 140B, e.g., a second communications link; and communications link 140C, e.g., a third communications link.

As seen in FIG. 1, borrower computing system 100 typically includes a central processing unit (CPU) 101, a communications interface 105, and a memory system 103. In one embodiment, memory system 103 includes all, or part of, a process for providing secure loan-based transactions 200.

In one embodiment, memory system 103 includes all, or part of, loan request data 110, loan approval terms data 111, purchase request data 112, loan balance data 113, purchase approval/terms data 114, transaction/delivery confirmation data 115, and feedback/confirmation data 116, that are discussed in more detail below.

In one embodiment, borrower computing system 100 is a mobile computing system such as, but not limited to: a mobile phone; a smart phone; an internet appliance; any SMS capable system; or any other mobile computing system as discussed herein, and/or as known in the art at the time of filing, and/or as developed after the time of filing.

In one embodiment, borrower computing system 100 is any computing system discussed herein, and/or as known in the art at the time of filing, and/or as developed after the time of filing that includes components that can execute all, or part, of process for providing secure loan-based transactions 200 in accordance with at least one of the embodiments as described herein.

In various embodiments, borrower computing system 100 may further include standard consumer interface devices such as a keyboard (not shown), a mouse (not shown), a printer (not shown), and a display device (not shown), as well as, one or more standard input/output (I/O) devices (not shown), such as a compact disk (CD) or Digital Video Disc (DVD) drive, floppy disk drive, or other device capable of inputting data to, and outputting data from, borrower computing system 100, whether available or known at the time of filing or as later developed.

In one embodiment, process for providing secure loan-based transactions 200 is entered, in whole, or in part, into borrower computing system 100 via an I/O device (not shown), such as from a CD, DVD, floppy disk, portable hard drive, memory stick, download site, or other medium and/or computer program product as defined herein.

As also seen in FIG. 1, merchant computing system 150 typically includes a central processing unit (CPU) 151, a communications interface 155, and a memory system 153. In one embodiment, memory system 153 includes all, or part of, process for providing secure loan-based transactions 200.

In one embodiment, memory system 153 includes all, or part of, purchase request data 112, purchase approval/terms data 114, and transaction/delivery confirmation data 115, that are discussed in more detail below.

In one embodiment, merchant computing system 150 is a mobile computing system such as, but not limited to: a mobile phone; a smart phone; an internet appliance; any SMS capable system; or any other mobile computing system as discussed herein, and/or as known in the art at the time of filing, and/or as developed after the time of filing.

In one embodiment, merchant computing system 150 is any computing system discussed herein, and/or as known in the art at the time of filing, and/or as developed after the time of filing that includes components that can execute all, or part, of process for providing secure loan-based transactions 200 in accordance with at least one of the embodiments as described herein.

In various embodiments, merchant computing system 150 may further include standard consumer interface devices such as a keyboard (not shown), a mouse (not shown), a printer (not shown), and a display device (not shown), as well as, one or more standard input/output (I/O) devices (not shown), such as a compact disk (CD) or Digital Video Disc (DVD) drive, floppy disk drive, or other device capable of inputting data to, and outputting data from, borrower computing system 100, whether available or known at the time of filing or as later developed.

In one embodiment, process for providing secure loan-based transactions 200 is entered, in whole, or in part, into borrower computing system 100 via an I/O device (not shown), such as from a CD, DVD, floppy disk, portable hard drive, memory stick, download site, or other medium and/or computer program product as defined herein.

As seen in FIG. 1, in one embodiment, loan program provider system 120 includes one or more processors, CPU(s) 121, a communication interface 122, and a memory 123.

As seen in FIG. 1, in one embodiment, memory 123 includes all, or part of, a process for providing secure loan-based transactions 200.

As seen in FIG. 1, in one embodiment, memory 123, and/or process for providing secure loan-based transactions 200, includes: loan request data 110 as received from borrower computing system 100; purchase request data 112 as received from borrower computing system 100, and/or as forwarded to merchant computing system 150; approved merchants and/or products data 160, as received from database 170; and feedback/confirmation data 116 as received from borrower computing system 100.

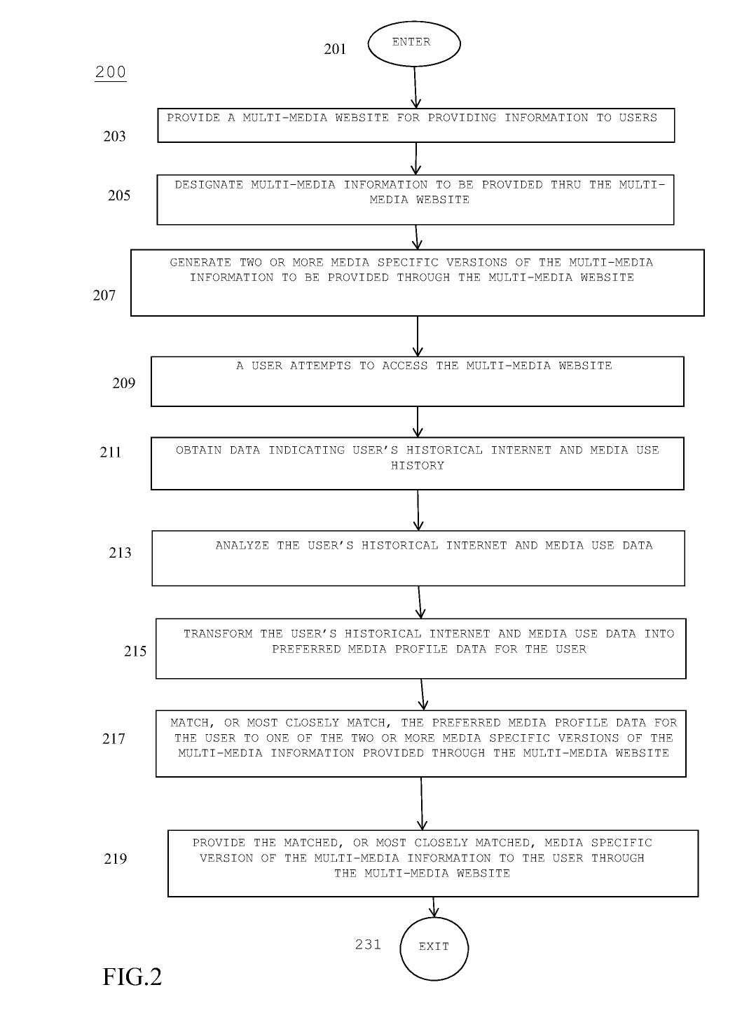

As seen in FIG. 1, and as discussed in more detail below, loan request data 110, purchase request data 112, approved merchants and/or products data 160, and/or feedback/confirmation data 116 are used as input to loan analysis/monitoring module 132. As also seen in FIG. 2, loan analysis/monitoring module 132 includes borrower account data 134, including data indicating a balance of funds in a secure transaction loan account associated with the borrower that is output as at least part of loan balance data 113.

As also seen in FIG. 1, the output of loan analysis/monitoring module 132 includes: loan approval terms data 111, as sent to borrower computing system 100; loan balance data 113, as sent to borrower computing system 100; purchase approval/terms data 114, as sent to borrower computing system 100 and/or merchant computing system 150; and transaction/delivery confirmation data 115, as sent to borrower computing system 100 and/or merchant computing system 150, that are discussed in more detail below.

In various embodiments, loan program provider system 120 is any computing system discussed herein, and/or as known in the art at the time of filing, and/or as developed after the time of filing that includes components that can execute all, or part, of a process for providing secure loan-based transactions, in accordance with at least one of the embodiments as described herein.

Also shown in FIG. 1 is database 170. In one embodiment, database 170 is a data storage device, a designated server system or computing system, or a designated portion of one or more server systems or computing systems, such as computing systems 100, 150 and 120, or a distributed database, or an external and/or portable hard drive. In one embodiment, database 170 is a dedicated mass storage device implemented in software, hardware, or a combination of hardware and software. In one embodiment, database 170 is a web-based function.

As discussed in more detail below, in one embodiment, database 170 is under the control of a process for providing secure loan-based transactions, such as exemplary process 200, and includes all, or part of, approved merchants and/or products data 160.

In one embodiment, computing systems 100 and 150, and database 170, are linked to loan program provider system 120 via communications channels 140A, 140B, and 140C, respectively. In various embodiments, any, or all, of communications channels 140A, 140B, and 140C can be, but are not limited to: a mobile communication link, such as a mobile phone link; a land-line phone link; a cable-based communications link; a satellite communications link; the Internet, or other network communications link; and/or any other communications link, or combination of communications links, as discussed herein, and/or as known in the art at the time of filing, and/or as developed after the time of filing.

In various embodiments, any, or all, of communications channels 140A, 140B, and 140C, are any SMS communication link as discussed herein, and/or as known in the art at the time of filing, and/or as developed after the time of filing. Short Message Service (SMS) is the text communication service component of phone, web, or mobile communication systems. SMS uses relatively ridged standardized communications protocols that allow the exchange of only very short text messages between fixed line or mobile phone devices in “SMS format”.

In various embodiments any, or all, of communications channels 140A, 140B, and 140C include any network or network system that is of interest to a consumer such as, a peer-to-peer network, a hybrid peer-to-peer network, a Local Area Network (LAN), a Wide Area Network (WAN), a public network, such as the Internet, a private network, a combination of different network types, or other wireless, wired, and/or a wireless and wired combination network capable of allowing communication between two or more computing systems, whether available or known at the time of filing or as later developed.

In one embodiment, computing systems 100 and 150, database 170, loan program provider system 120, and any, or all, of communications channels 140A, 140B, and 140C, are part of a cloud computing environment.

In accordance with one embodiment, a potential borrower applies for a secure transaction business loan through the secure transaction business loan program associated with program provider system 120. In various embodiments, as part of the application process, the potential borrower provides various loan application/request information/data, such as loan request data 110, to program provider system 120.

In one embodiment, loan request data 110 is reviewed/analyzed by the provider of the secure transaction business loan program, and/or loan analysis/monitoring module 132, and loan approval/terms data 111 is generated and sent to borrower computing system 100.

In one embodiment, upon receipt of the borrower's acceptance of the approved secure transaction business loan and indication of agreement to the terms of the approved secure transaction business loan, a secure transaction business loan account, such as borrower account 134 is established and/or associated with the borrower and the approved secure transaction business loan funds are transferred to the borrower's secure transaction business loan account. However, according to various embodiments, neither the borrower, nor any party other than an approved merchant, is provided direct access to secure transaction business loan funds. Therefore, only approved merchants receive cash from the secure transaction business loan account. As a result, using process for providing secure loan-based transactions 200, the provider of the secure transaction business loan, and/or lender, retains some control over how the secure transaction business loan funds are spent. In addition, using process for providing secure loan-based transactions 200, there is no opportunity for family members, or any other parties, to steal/misappropriate the secure transaction business loan funds.

In one embodiment, when the borrower determines one or more products and/or services they need to purchase using the secure transaction business loan funds, the borrower submits purchase request data 112 to loan program provider system 120.

In one embodiment, purchase request data 112 is analyzed by the provider of the secure transaction business loan program, and/or loan analysis/monitoring module 132, to determine one or more of, but not limited to: the type and/or suitability of the products and/or services the borrower desires to purchase and/or if the products and/or services are listed in the approved merchants and/or products data 160; the stated, estimated, or determined, cost of the products and/or services the borrower desires purchase; the balance of funds in the borrower's secure transaction business loan account as calculated using loan balance data 113; the merchant, or merchants, from which the items will be purchased and/or the suitability of the merchant(s), and/or whether any specifically requested merchant is included in approved merchants and/or products data 160; and/or any other information/data in the purchase request.

In one embodiment, the borrower's purchase request is approved by the secure transaction business loan program provider and purchase approval/terms data 114 is generated and sent to borrower computing system 100 and/or merchant computing system 150.

In various embodiments, in response to the borrower's purchase request, along with the approval notification, the secure transaction business loan program provider provides the borrower with one or more of the following approved loan information/data: information/data representing a listing of pre-approved, or in network, merchants capable of providing the products and/or services that are the subject of the purchase request from approved merchants and/or products data 160; information/data indicating the actual, or estimated, market price for the products and/or services that are the subject of the purchase request, as calculated/obtained by the secure transaction business loan program provider; information/data indicating a projected balance of funds in the borrower's secure transaction business loan account that will remain after the purchase of the products and/or services, such as projected using loan balance data 113; information/data indicating a list of approved products and/or services of approved merchants and/or products data 160 that is a subset of the products and/or services that are the subject of the purchase request data 112; or any other data/information deemed to potentially be of interest to the borrower.

In one embodiment, purchase approval/terms data 114 indicating the products and/or services that are the subject of the approved purchase request is presented to two or more merchants, and/or merchant computing systems 150, who can provide the approved products and/or services. In one embodiment, the two or more merchants are provided the opportunity to bid for the business, thereby potentially providing the borrower with a better price.

In one embodiment, once a merchant is designated/approved to provide the products and/or services associated with the approved purchase request, the provider of the secure transaction business loan program either transfers, or arranges for the future transfer of, the required payment funds for the approved products and/or services from borrower's secure transaction business loan account directly to the designated/approved merchant, i.e., without providing the funds to the borrower. Consequently, neither the borrower, nor any party other than the designated/approved merchant, is provided direct access to secure transaction business loan funds. Therefore, only the designated/approved merchant can receive cash from the secure transaction business loan account. As a result, using process for providing secure loan-based transactions 200, the provider of the secure transaction business loan retains some control over how the secure transaction business loan funds are spent. In addition, using process for providing secure loan-based transactions 200, there is no opportunity for family members, or any other parties, to steal/misappropriate the secure transaction business loan funds.

In one embodiment, transaction/delivery confirmation data 115 is sent to borrower computing system 100 whereby the borrower informed of the completed financial transaction, or the pending financial transaction, and the borrower is also provided pickup and/or delivery information/data indicating where and how the borrower can physically obtain the approved products and/or services associated with the approved purchase request.

In one embodiment, the borrower is provided the opportunity to submit feedback/confirmation data 116, confirming receipt of the products and/or services and comments regarding the secure transaction business loan program, the products and/or services obtained, and/or the merchant(s) providing the products and/or services. In various embodiments, this ensures that the secure transaction business loan program is self-learning and that the merchants in the approved merchant network are performing to the standards set by the provider of the secure transaction business loan program.

Those of skill in the art will readily recognize that the components shown in FIG. 1 and their respective sub-components, are shown for illustrative purposes only and that architectures with more or fewer components can implement, and benefit from, the invention. Moreover, one or more components may be located remotely from their respective system and accessed via network, as discussed herein. In addition, the particular type of, and configuration of, computing systems 100, 150, database 170, and loan program provider system 120 are not relevant.

Although a process for providing secure loan-based transactions, such as process for providing secure loan-based transactions 200, is sometimes referred to herein, alternatively, as a process, an application, a module, a program, a component of a software system, a component of a software package, a component of a parent system, a plug-in, or a feature of a parent system, this terminology is illustrative only. In some embodiments, a process for providing secure loan-based transactions, such as process for providing secure loan-based transactions 200, is capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPU(s) 101, 151, or 121.

In one embodiment, a process for providing secure loan-based transactions, such as process for providing secure loan-based transactions 200, is a computer application or process implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, or other media or process capable of delivering computer readable data representing computer readable code, whether available or known at the time of filing or as later developed. This medium may belong to a computing system, such as computing systems 100 and 150 of FIG. 1, described above. However, in some embodiments, the medium also may be removable and/or remote from the computing system.

### Process

In accordance with one embodiment, a method and system for providing secure loan-based transactions includes a process for providing secure loan-based transactions whereby, in one embodiment, a loan is made to a borrower such that the loan funds remain in an account associated with the borrower and cannot be directly accessed by the borrower as cash/currency. In one embodiment, the borrower submits a purchase request to the loan program provider indicating items the borrower desires to purchase via a secure loan-based transaction using the approved loan funds. In one embodiment, the borrower's purchase request is analyzed to determine one or more of, but not limited to, the type and/or suitability of the items the borrower desires to purchase, the estimated or actual cost of the items the borrower desires purchase, the balance of funds in the borrower's loan account, the merchant, or merchants, from which the items will be purchased and/or the suitability of the merchant(s), and/or any other purchase request information/data desired and/or available. In one embodiment, if the requested purchase is deemed appropriate, the purchase is approved. In one embodiment, the funds required to make the approved purchase are then transferred from the borrower's loan account to the designated/approved merchant(s) directly, without the transfer of cash to the borrower. In one embodiment, the borrower is then informed of the completed financial transaction and the requested purchase items are obtained by, and/or delivered to, the borrower.

FIG. 2 a flow chart depicting a process for providing secure loan-based transactions 200 in accordance with one embodiment. Process for providing secure loan-based transactions 200 begins at ENTER OPERATION 201 of FIG. 2 and process flow proceeds to PROVIDE A SECURE TRANSACTION BUSINESS LOAN PROGRAM OPERATION 203.

In one embodiment, at PROVIDE A SECURE TRANSACTION BUSINESS LOAN PROGRAM OPERATION 203 a secure transaction business loan program is provided.

In various embodiments, the secure transaction business loan program is provided at PROVIDE A SECURE TRANSACTION BUSINESS LOAN PROGRAM OPERATION 203 by one or more of, but not limited to, private banks, financial institutions, lending agencies, government agencies, international agencies, charities, and/or other public and private parties.

In various embodiments, the secure transaction business loan program is implemented at PROVIDE A SECURE TRANSACTION BUSINESS LOAN PROGRAM OPERATION 203 using, and/or is intended for use with, traditional computing system architectures and infrastructure.

Herein, the term “computing system” includes, but is not limited to, any computing system known in the art at the time of filing, and/or as developed after the time of filing, such as, but not limited to: a mobile computing system; a desktop computing system; a laptop computing system; a notebook computing system; a workstation; a two-way pager; a cellular telephone; a smart phone; a digital wireless telephone; a Personal Digital Assistant (PDA); a server computer; an Internet appliance, any other device, or any desired combination of these devices, that includes components that can execute all, or part, of a process for providing secure loan-based transactions in accordance with at least one of the embodiments as discussed herein, and/or as known in the art at the time of filing, and/or as developed after the time of filing.

In various embodiments, the secure transaction business loan program at PROVIDE A SECURE TRANSACTION BUSINESS LOAN PROGRAM OPERATION 203 is implemented using, and/or is intended for use with, other communications systems and infrastructure, such as, but not limited to, mobile communication systems.

Herein, the term “mobile computing system” includes, but not limited to: a mobile phone; a smart phone; an internet appliance; any Short Message Service (SMS) capable system; or any other mobile computing system as discussed herein, and/or as known in the art at the time of filing, and/or as developed after the time of filing capable of receiving SMS message traffic.

In various embodiments, the secure transaction business loan program at PROVIDE A SECURE TRANSACTION BUSINESS LOAN PROGRAM OPERATION 203 is implemented using an SMS communication infrastructure capable of being accessed and used through mobile computing systems, such as mobile phones, which are far more common and accessible in many parts of the world than traditional computing systems and Internet access. Consequently, one embodiment of the method and system for providing secure loan-based transactions discussed herein can be utilized even in parts of the world where traditional Internet access is not available.

In one embodiment, the secure transaction business loan program of PROVIDE A SECURE TRANSACTION BUSINESS LOAN PROGRAM OPERATION 203 provides secure transaction business loans and loan accounts to approved borrowers such that the approved loan funds remain in an account associated with the borrower and cannot be directly accessed by the borrower as cash/currency.

In one embodiment, the secure transaction business loan program of PROVIDE A SECURE TRANSACTION BUSINESS LOAN PROGRAM OPERATION 203 is specifically directed to making secure transaction business loans to borrowers who do not qualify for more traditional business loans.

In one embodiment, the secure transaction business loan program of PROVIDE A SECURE TRANSACTION BUSINESS LOAN PROGRAM OPERATION 203 is specifically directed to operating in a microcredit environment and providing secure transaction microloans.

In one embodiment, the secure transaction business loan program of PROVIDE A SECURE TRANSACTION BUSINESS LOAN PROGRAM OPERATION 203 is specifically directed to making secure transaction business loans to borrowers in designated areas, such as areas having developing/emerging economies.

As discussed in more detail below, in some embodiments, the secure transaction business loan program of PROVIDE A SECURE TRANSACTION BUSINESS LOAN PROGRAM OPERATION 203 includes, determines, and/or is associated with, one or more databases, such as database 170 of FIG. 1, that include approved merchants and/or products data 160 identifying approved products and/or services that are considered appropriate for purchase using secure transaction business loan funds obtained through the secure transaction business loan program of PROVIDE A SECURE TRANSACTION BUSINESS LOAN PROGRAM OPERATION 203.

Returning to FIG. 2, as also discussed in more detail below, in some embodiments, the secure transaction business loan program of PROVIDE A SECURE TRANSACTION BUSINESS LOAN PROGRAM OPERATION 203 includes, sponsors, and/or is associated with, one or more networks of approved merchants and/or providers of products and services. In one embodiment, data indicating the approved merchants and/or providers of products and services, and data indicating products sold by the approved merchants and/or providers of products and services, is obtained from a database, such as database 170 in FIG. 1 and/or from approved merchants and/or products data 160.

Returning to FIG. 2, as also discussed in more detail below, in some embodiments, the secure transaction business loan program includes, determines, and/or is associated with, one or more databases including data for determining the relative real-time market price of various approved products and services.

In one embodiment, once a secure transaction business loan program is provided at PROVIDE A SECURE TRANSACTION BUSINESS LOAN PROGRAM OPERATION 203, process flow proceeds to A POTENTIAL BORROWER PROVIDES LOAN REQUEST DATA AND/OR EXPECTED LOAN USE DATA OPERATION 205.

In one embodiment, at A POTENTIAL BORROWER PROVIDES LOAN REQUEST DATA AND/OR EXPECTED LOAN USE DATA OPERATION 205 a potential borrower applies for a secure transaction business loan through the secure transaction business loan program of PROVIDE A SECURE TRANSACTION BUSINESS LOAN PROGRAM OPERATION 203.

In various embodiments, at A POTENTIAL BORROWER PROVIDES LOAN REQUEST DATA AND/OR EXPECTED LOAN USE DATA OPERATION 205 as part of the application process, the potential borrower provides various loan application/request information/data, such as loan request data 110 of FIG. 1.

Returning to FIG. 2, in various embodiments, the loan application/request information/data provided at A POTENTIAL BORROWER PROVIDES LOAN REQUEST DATA AND/OR EXPECTED LOAN USE DATA OPERATION 205 includes, but is not limited to, information/data indicating one or more of: identification and other personal information associated with the borrower, and/or the borrower's financial situation, such as, but not limited to, the borrower's name, identification numbers associated with the borrower, the borrower's address, any credit history or financial accounts associated with the borrower, etc.; the type of business the borrower intends to finance with the secure transaction business loan; the specific purpose of the secure transaction business loan, e.g., for purchasing inventory, for obtaining business space, for obtaining employees, etc.; the requested amount of the secure transaction business loan; the anticipated, or estimated, products and/or services to be purchased using the secure transaction business loan; and/or any other loan application/request information/data desired/required by the provider of the secure transaction business loan program.

In one embodiment, the loan application/request information/data is provided by the potential borrower at A POTENTIAL BORROWER PROVIDES LOAN REQUEST DATA AND/OR EXPECTED LOAN USE DATA OPERATION 205 in person, or in written/printed form. In one embodiment, the loan application/request information/data is provided at A POTENTIAL BORROWER PROVIDES LOAN REQUEST DATA AND/OR EXPECTED LOAN USE DATA OPERATION 205 by the potential borrower via one or more computing systems and the Internet. In one embodiment, the loan application/request is provided at A POTENTIAL BORROWER PROVIDES LOAN REQUEST DATA AND/OR EXPECTED LOAN USE DATA OPERATION 205 by the borrower via a mobile computing system, and/or one or more mobile applications, and/or one or more mobile communication systems, such as SMS.

In one embodiment, at A POTENTIAL BORROWER PROVIDES LOAN REQUEST DATA AND/OR EXPECTED LOAN USE DATA OPERATION 205 the loan application/request information/data is authenticated/verified to ensure the borrower's identity is legitimate and to verify any, or all, of the loan application/request information/data. In various embodiments, the loan application/request information/data is authenticated/verified using any mechanism, means, process, and/or procedure as discussed herein, and/or as known in the art at the time of filing, and/or as developed/made available after the time of filing.

In one embodiment, once a potential borrower applies for a secure transaction business loan through the secure transaction business loan program of PROVIDE A SECURE TRANSACTION BUSINESS LOAN PROGRAM OPERATION 203 at A POTENTIAL BORROWER PROVIDES LOAN REQUEST DATA AND/OR EXPECTED LOAN USE DATA OPERATION 205, process flow proceeds to THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207.

In one embodiment, the loan application/request information/data of A POTENTIAL BORROWER PROVIDES LOAN REQUEST DATA AND/OR EXPECTED LOAN USE DATA OPERATION 205 is reviewed/analyzed by the provider of the secure transaction business loan program and a decision is made to either approve, or disapprove, the requested secure transaction business loan.

As noted above, in some embodiments, the secure transaction business loan program is particularly directed to providing secure transaction business loans to borrowers who would not qualify for traditional loans due to one or more perceived financial disadvantages such as lack of collateral, steady employment, or any verifiable credit history. Consequently, in some embodiments, the decision to either approve, or disapprove, the requested secure transaction business loan is not made primarily on traditional financial analysis. Instead, in various embodiments, the decision to either approve, or disapprove, the requested secure transaction business loan is made based primarily on the type of business to be funded by the secure transaction business loan, the products and or services to be provided by the business to be funded by the secure transaction business loan, and the perceived contribution to the community by the business to be funded by the secure transaction loan.

In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the requested secure transaction business loan is conditionally approved, the borrower is informed of the approval and the conditions of approval, including the operational rules for using the secure transaction business loan.

In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the requested secure transaction business loan is conditionally approved, the borrower is informed of the approval and the conditions of approval, including the operational rules for using the secure transaction business loan, via loan approval/terms data, such as loan approval/terms data 111 of FIG. 1.

Returning to FIG. 2, in various embodiments, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower is informed of the approved amount of the secure transaction business loan along with information/data indicating one or more of, but not limited to, the following: the terms of the secure transaction business loan, including repayment plans, interest, and any other charges/responsibilities to be imposed upon the borrower; the specific purpose intended for the secure transaction business loan and any limitations on the use of the secure transaction business loan funds, i.e., what business the secure transaction business loan is intended to fund; what products and/or services the secure transaction business loan is intended to fund, including, in one embodiment, data indicating what products and/or services are considered appropriate for purchase using the secure transaction business loan funds and any other limitations on the use of the secure transaction business loan funds; what merchants, if any, are approved to provide the products and/or services to the borrower, including, in one embodiment, data indicating merchants who are in a pre-approved merchant network associated with the secure transaction business loan program; how to submit a purchase request to use the secure transaction business loan funds; and/or any other information the provider of the secure transaction business loan program, and/or lender, desires to provide the borrower at the time the secure transaction business loan is approved.

In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower is informed of the approved amount of the secure transaction business loan along with approval information/data by written correspondence. In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower is informed of the approved amount of the secure transaction business loan along with approval information/data via one or more computing systems and the Internet. In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower is informed of the approved amount of the secure transaction business loan along with approval information/data via a mobile computing system, and/or one or more mobile applications, and/or one or more mobile communication systems, such as SMS.

In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower accepts the approved secure transaction business loan and indicates agreement to the terms of the approved secure transaction business loan.

In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower accepts the approved secure transaction business loan and indicates agreement to the terms of the approved secure transaction business loan by written correspondence. In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the borrower accepts the approved secure transaction business loan and indicates agreement to the terms of the approved secure transaction business loan via one or more computing systems and the Internet. In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 borrower accepts the approved secure transaction business loan and indicates agreement to the terms of the approved secure transaction business loan via a mobile computing system, and/or one or more mobile applications, and/or one or more mobile communication systems, such as SMS.

In one embodiment, upon receipt of the borrower's acceptance of the approved secure transaction business loan and indication of agreement to the terms of the approved secure transaction business loan at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207, a secure transaction business loan account is established and/or associated with the borrower.

In one embodiment, at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207 the approved secure transaction business loan funds are transferred to the borrower's secure transaction business loan account. However, according to various embodiments, neither the borrower, nor any party other than an approved merchant, is provided direct access to secure transaction business loan funds, i.e., the loan is conditional and approved only for transfer transactions for the purpose of obtaining approved products and/or services. Therefore, only approved merchants receive cash from the secure transaction business loan account.

As a result, using process for providing secure loan-based transactions 200, the provider of the secure transaction business loan, and/or lender, retains some control over how the secure transaction business loan funds are spent. In addition, using process for providing secure loan-based transactions 200, there is no opportunity for family members, or any other parties, to steal/misappropriate the secure transaction business loan funds.

In one embodiment, once the requested secure transaction business loan is conditionally approved, the borrower is informed of the approval and the conditions of approval, including the operational rules for using the secure transaction business loan at THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207, process flow proceeds to THE BORROWER SUBMITS A REQUEST TO USE AT LEAST PART OF THE DESIGNATED LOAN FUNDS TO MAKE A REQUESTED PURCHASE OPERATION 209.

In one embodiment, at THE BORROWER SUBMITS A REQUEST TO USE AT LEAST PART OF THE DESIGNATED LOAN FUNDS TO MAKE A REQUESTED PURCHASE OPERATION 209 the borrower determines one or more products and/or services they need to purchase using the secure transaction business loan funds of THE LOAN IS CONDITIONALLY APPROVED AND THE APPROVED LOAN FUNDS ARE PLACED IN A LOAN ACCOUNT ASSOCIATED WITH THE BORROWER, BUT NOT DIRECTLY ACCESSIBLE BY THE BORROWER, FOR TRANSFER TO DESIGNATED/APPROVED MERCHANTS TO MAKE APPROVED PURCHASES OPERATION 207, and the borrower submits a purchase request to the secure transaction business loan program provider.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating the products and/or services the borrower desires to purchase and/or the number/amount of products and/or services the borrower desires to purchase.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 is submitted as purchase request data, such as purchase request data 112 of FIG. 1.

Returning the FIG. 2, in various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating the estimated, or known, cost of the products and/or services the borrower desires to purchase, as determined by the borrower.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating a request by the borrower for the estimated, or known, cost of the products and/or services the borrower desires to purchase, as to be determined by the secure transaction business loan program and/or the secure transaction business loan program provider.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating a request for a listing of pre-approved merchants, or “in-network” merchants associated with the products and/or services the borrower desires to purchase.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating the name, and/or location, of a given merchant from which the borrower desires to purchase the products and/or services.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating a date, or date range, the borrower desires to purchase, and/or obtain, the desired products and/or services, and/or a time of day the borrower desires to purchase, and/or obtain, the desired products and/or services.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating a location where the borrower desires to pick up, or take delivery of, the desired products and/or services once purchased.

In various embodiments, the purchase request of THE BORROWER SUBMITS A REQUEST TO USE AT LEAST PART OF THE DESIGNATED LOAN FUNDS TO MAKE A REQUESTED PURCHASE OPERATION 209 includes, but not is not limited to, information/data indicating any other purchase request information desired by the secure transaction business loan program provider, and/or one or more merchants, and/or the borrower.

In one embodiment, the purchase request information/data of THE BORROWER SUBMITS A REQUEST TO USE AT LEAST PART OF THE DESIGNATED LOAN FUNDS TO MAKE A REQUESTED PURCHASE OPERATION 209 is provided by the potential borrower in person, or in written/printed form. In one embodiment, the loan purchase request information/data of THE BORROWER SUBMITS A REQUEST TO USE AT LEAST PART OF THE DESIGNATED LOAN FUNDS TO MAKE A REQUESTED PURCHASE OPERATION 209 is provided by the potential borrower via one or more computing systems and the Internet. In one embodiment, the purchase request information/data of THE BORROWER SUBMITS A REQUEST TO USE AT LEAST PART OF THE DESIGNATED LOAN FUNDS TO MAKE A REQUESTED PURCHASE OPERATION 209 is provided by the borrower via a mobile computing system, and/or one or more mobile applications, and/or one or more mobile communication systems, such as SMS.

In one embodiment, once the borrower submits a purchase request to the secure transaction business loan program provider at THE BORROWER SUBMITS A REQUEST TO USE AT LEAST PART OF THE DESIGNATED LOAN FUNDS TO MAKE A REQUESTED PURCHASE OPERATION 209, process flow proceeds to ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211.

In one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request of THE BORROWER SUBMITS A REQUEST TO USE AT LEAST PART OF THE DESIGNATED LOAN FUNDS TO MAKE A REQUESTED PURCHASE OPERATION 209 is analyzed by the secure transaction business loan program provider.

In one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request of THE BORROWER SUBMITS A REQUEST TO USE AT LEAST PART OF THE DESIGNATED LOAN FUNDS TO MAKE A REQUESTED PURCHASE OPERATION 209 is analyzed by the secure transaction business loan program provider using a loan analysis/monitoring module, such as loan analysis/monitoring module 132 of FIG. 1, and/or one or more processors, such as CPU(s) 121 of FIG. 1, associated with one or more loan program provider systems, such as loan program provider system 120 of FIG. 1.

Returning to FIG. 2, in one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine the type and/or suitability of the products and/or services the borrower desires to purchase using approved products data, such as approved merchant and/or products data 160 of FIG. 1.

Returning to FIG. 2, in one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine the stated, estimated, or determined, cost of the products and/or services the borrower desires purchase, as determined by the borrower.

In one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine the stated, estimated, or determined, cost of the products and/or services the borrower desires purchase, as determined by the secure transaction business loan program, and/or the secure transaction business loan program provider.

In one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine the balance of funds in the borrower's secure transaction business loan account and to determine loan balance data, such as loan balance data 113 of FIG. 1.

Returning top FIG. 2, in one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine the merchant, or merchants, from which the items will be purchased using approved merchant data, such as approved merchant and/or products data 160 of FIG. 1.

Returning to FIG. 2, in one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine the suitability of the merchant(s), and/or whether any specifically requested merchant is in the network of pre-approved merchants using approved merchant data, such as approved merchant and/or products data 160 of FIG. 1

Returning to FIG. 2, in one embodiment, at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211 the borrower's purchase request is analyzed to determine any other information/data in the purchase request desired/required by the secure transaction business loan program provider.

In one embodiment, once the borrower's purchase request of THE BORROWER SUBMITS A REQUEST TO USE AT LEAST PART OF THE DESIGNATED LOAN FUNDS TO MAKE A REQUESTED PURCHASE OPERATION 209 is analyzed by the secure transaction business loan program provider at ANALYZE THE REQUESTED PURCHASE AND THE BALANCE OF THE APPROVED LOAN FUNDS TO MAKE RECOMMENDATIONS AND/OR APPROVE OR DISAPPROVE THE REQUESTED PURCHASE OPERATION 211, process flow proceeds to APPROVE THE REQUESTED PURCHASE AND ESTABLISH TRANSACTION REQUIREMENTS/CONDITIONS OPERATION 213.

In one embodiment, at APPROVE THE REQUESTED PURCHASE AND ESTABLISH TRANSACTION REQUIREMENTS/CONDITIONS OPERATION 213 the borrower's purchase request is approved by the secure transaction business loan program provider and the borrower is provided with approved loan information/data.

In one embodiment, at APPROVE THE REQUESTED PURCHASE AND ESTABLISH TRANSACTION REQUIREMENTS/CONDITIONS OPERATION 213 the borrower's purchase request is approved by the secure transaction business loan program provider and the borrower is provided with approved loan information/data, such as purchase approval/terms data 114 of FIG. 1.

Returning to FIG. 2, in various embodiments, at APPROVE THE REQUESTED PURCHASE AND ESTABLISH TRANSACTION REQUIREMENTS/CONDITIONS OPERATION 213 the secure transaction business loan program provider provides the borrower with approved loan information/data representing a listing of pre-approved, or in network, merchants capable of providing the products and/or services that are the subject of the purchase request.

In various embodiments, at APPROVE THE REQUESTED PURCHASE AND ESTABLISH TRANSACTION REQUIREMENTS/CONDITIONS OPERATION 213 the secure transaction business loan program provider provides the borrower with approved loan information/data indicating the actual, or estimated, market price for the products and/or services that are the subject of the purchase request, as calculated/obtained by the secure transaction business loan program provider.

In various embodiments, at APPROVE THE REQUESTED PURCHASE AND ESTABLISH TRANSACTION REQUIREMENTS/CONDITIONS OPERATION 213 the secure transaction business loan program provider provides the borrower with approved loan information/data indicating a projected balance of funds in the borrower's secure transaction business loan account that will remain after the purchase of the products and/or services, such as loan balance data 113 of FIG. 1.

Returning to FIG. 2, in various embodiments, at APPROVE THE REQUESTED PURCHASE AND ESTABLISH TRANSACTION REQUIREMENTS/CONDITIONS OPERATION 213 the secure transaction business loan program provider provides the borrower with approved loan information/data indicating a list of approved products and/or services that is a subset of the products and/or services that are the subject of the purchase request determined using approved product data, such as approved merchants and/or products data 160 of FIG. 1.

Returning to FIG. 2, in various embodiments, at APPROVE THE REQUESTED PURCHASE AND ESTABLISH TRANSACTION REQUIREMENTS/CONDITIONS OPERATION 213 the secure transaction business loan program provider provides the borrower with any approved loan information/data deemed to potentially be of interest to the borrower.

In one embodiment, at APPROVE THE REQUESTED PURCHASE AND ESTABLISH TRANSACTION REQUIREMENTS/CONDITIONS OPERATION 213 the approval and/or approved loan information/data is provided to the borrower in person, or in written/printed form. In one embodiment, the approval and/or approved loan information/data is provided to the borrower at APPROVE THE REQUESTED PURCHASE AND ESTABLISH TRANSACTION REQUIREMENTS/CONDITIONS OPERATION 213 via one or more computing systems and the Internet. In one embodiment, the approval and/or approved loan information/data is provided to the borrower at APPROVE THE REQUESTED PURCHASE AND ESTABLISH TRANSACTION REQUIREMENTS/CONDITIONS OPERATION 213 via a mobile computing system, and/or one or more mobile applications, and/or one or more mobile communication systems, such as SMS.

In one embodiment, at APPROVE THE REQUESTED PURCHASE AND ESTABLISH TRANSACTION REQUIREMENTS/CONDITIONS OPERATION 213 the borrower's identity is again verified before any funds are released.

In one embodiment, at APPROVE THE REQUESTED PURCHASE AND ESTABLISH TRANSACTION REQUIREMENTS/CONDITIONS OPERATION 213 the products and/or services that are the subject of the approved purchase request are presented to one or more merchants in the approved merchant network who can provide the approved products and/or services as purchase approval/terms data, such as purchase approval/terms data 114 of FIG. 1.

Returning to FIG. 2, in one embodiment, APPROVE THE REQUESTED PURCHASE AND ESTABLISH TRANSACTION REQUIREMENTS/CONDITIONS OPERATION 213 the products and/or services that are the subject of the approved purchase request are presented to two or more merchants in the approved merchant network who can provide the approved products and/or services via one or more merchant computing systems, such as merchant computing system 150 of FIG. 1. In one embodiment, the two or more merchants are provided the opportunity to bid for the business, thereby potentially providing the borrower with a better price.

In one embodiment, once the borrower's purchase request is approved by the secure transaction business loan program provider and the borrower is provided with approved loan information/data at APPROVE THE REQUESTED PURCHASE AND ESTABLISH TRANSACTION REQUIREMENTS/CONDITIONS OPERATION 213, process flow proceeds to EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215.

In one embodiment, at EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215 the provider of the secure transaction business loan program either transfers, or arranges for the future transfer of, the required payment funds for the approved products and/or services of APPROVE THE REQUESTED PURCHASE AND ESTABLISH TRANSACTION REQUIREMENTS/CONDITIONS OPERATION 213 from borrower's secure transaction business loan account.

In one embodiment, once a merchant is designated/approved to provide the products and/or services associated with the approved purchase request, at EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215, the provider of the secure transaction business loan program either transfers, or arranges for the future transfer of, the required payment funds for the approved products and/or services from borrower's secure transaction business loan account directly to the designated/approved merchant, i.e., without providing the funds to the borrower. Consequently, neither the borrower, nor any party other than the designated/approved merchant, is provided direct access to secure transaction business loan funds. Therefore, only the designated/approved merchant can receive cash from the secure transaction business loan account.

As a result, using process for providing secure loan-based transactions 200, the provider of the secure transaction business loan retains some control over how the secure transaction business loan funds are spent. In addition, using process for providing secure loan-based transactions 200, there is no opportunity for family members, or any other parties, to steal/misappropriate the secure transaction business loan funds.

In one embodiment, at EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215 the borrower is informed of the completed financial transaction, or the pending financial transaction.

In one embodiment, at EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215 the borrower is informed of the completed financial transaction, or the pending financial transaction using transaction/delivery confirmation data, such as transaction/delivery confirmation data 115 of FIG. 1.

Returning to FIG. 2, in one embodiment, at EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215 the borrower is also provided pickup and/or delivery information/data indicating where and how the borrower can physically obtain the approved products and/or services associated with the approved purchase request, in one embodiment, using transaction/delivery confirmation data, such as transaction/delivery confirmation data 115 of FIG. 1.

In various embodiments, the transaction/delivery confirmation data, such as transaction/delivery confirmation data 115 of FIG. 1, is also provided to the approved merchant, in one embodiment via a merchant computing system, such as merchant computing system 150 of FIG. 1.

Returning to FIG. 1, in one embodiment, the completed financial transaction, and/or delivery/pick up information/data, is provided to the borrower in person, or in written/printed form. In one embodiment, the completed financial transaction, and/or delivery/pick up information/data, is provided to the borrower via one or more computing systems and the Internet. In one embodiment, the completed financial transaction, and/or delivery/pick up information/data, is provided to the borrower via a mobile computing system, and/or one or more mobile applications, and/or one or more mobile communication systems, such as SMS.

In one embodiment, once the provider of the secure transaction business loan program either transfers, or arranges for the future transfer of, the required payment funds for the approved products and/or services from borrower's secure transaction business loan account at EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215, process flow proceeds to THE BORROWER OBTAINS/TAKES DELIVERY OF THE APPROVED PURCHASE ITEMS FROM THE DESIGNATED/APPROVED MERCHANT ASSOCIATED WITH THE APPROVED PURCHASE OPERATION 217.

In one embodiment, at THE BORROWER OBTAINS/TAKES DELIVERY OF THE APPROVED PURCHASE ITEMS FROM THE DESIGNATED/APPROVED MERCHANT ASSOCIATED WITH THE APPROVED PURCHASE OPERATION 217 the borrower obtains, or takes delivery of the approved, and paid for, products and/or services of EXECUTE A TRANSACTION TO MAKE THE REQUESTED PURCHASE BY TRANSFERRING THE FUNDS REQUIRED TO MAKE THE APPROVED PURCHASE FROM THE LOAN ACCOUNT ASSOCIATED WITH THE BORROWER DIRECTLY TO THE DESIGNATED/APPROVED MERCHANT ASSOCIATED WITH THE APPROVED PURCHASE OPERATION 215 according to the terms of the approved loan information/data at APPROVE THE REQUESTED PURCHASE AND ESTABLISH TRANSACTION REQUIREMENTS/CONDITIONS OPERATION 213.

In one embodiment, at THE BORROWER OBTAINS/TAKES DELIVERY OF THE APPROVED PURCHASE ITEMS FROM THE DESIGNATED/APPROVED MERCHANT ASSOCIATED WITH THE APPROVED PURCHASE OPERATION 217 the borrower's identity is again verified before any products are released.

In one embodiment, at THE BORROWER OBTAINS/TAKES DELIVERY OF THE APPROVED PURCHASE ITEMS FROM THE DESIGNATED/APPROVED MERCHANT ASSOCIATED WITH THE APPROVED PURCHASE OPERATION 217 the borrower is provided the opportunity to submit feedback/confirmation data, such as feedback/confirmation data 116 of FIG. 1, confirming receipt of the products and/or services and comments regarding the secure transaction business loan program, the products and/or services obtained, and/or the merchant(s) providing the products and/or services. In various embodiments, this ensures that the secure transaction business loan program is self-learning and that the merchants in the approved merchant network are performing to the standards set by the provider of the secure transaction business loan program.

Returning to FIG. 2, in one embodiment, the borrower provides the feedback information/data in person, or in written/printed form. In one embodiment, the borrower provides the feedback information/data via one or more computing systems and the Internet. In one embodiment, the borrower provides the feedback information/data via a mobile computing system, and/or one or more mobile applications, and/or one or more mobile communication systems, such as SMS.

In one embodiment, once the borrower obtains, or takes delivery of the approved, and paid for, products and/or services according to the terms of the approved loan information/data, and/or submit feedback, at THE BORROWER OBTAINS/TAKES DELIVERY OF THE APPROVED PURCHASE ITEMS FROM THE DESIGNATED/APPROVED MERCHANT ASSOCIATED WITH THE APPROVED PURCHASE OPERATION 217, process flow proceeds to EXIT OPERATION 231.

In one embodiment at EXIT OPERATION 231 process for providing secure loan-based transactions 200 is exited to await new data.

Using process for providing secure loan-based transactions 200, a borrower can only use loan funds for purchases approved by a loan program provider. As a result, the lender is provided input to, and some control over, how the loan funds are used. In addition, using process for providing secure loan-based transactions 200, the borrower is never provided cash, or direct access to cash, consequently, the loan funds are relatively protected from loss, theft, or other misappropriation; even theft/misappropriation by a spouse or family member. Consequently, using process for providing secure loan-based transactions 200, even loans made in the absence of collateral are made more secure/less risky, and are more likely to be paid back. As a result, more loans will be made and more potential business owners will be provided the opportunity to succeed. In addition, when process for providing secure loan-based transactions 200 is applied to microcredit/microloan systems, and more of these loans are made, the lives of the some of the world's poorest individuals will be dramatically improved, and in some cases literally saved.

In the discussion above, certain aspects of one embodiment include process steps or operations or instructions described herein for illustrative purposes in a particular order or grouping. However, the particular order or grouping shown and discussed herein is illustrative only and not limiting. Those of skill in the art will recognize that other orders or grouping of the process steps or operations or instructions are possible and, in some embodiments, one or more of the process steps or operations or instructions discussed above can be combined or deleted. In addition, portions of one or more of the process steps or operations or instructions can be re-grouped as portions of one or more other of the process steps or operations or instructions discussed herein. Consequently, the particular order or grouping of the process steps or operations or instructions discussed herein does not limit the scope of the invention as claimed below.

As discussed in more detail above, using the above embodiments, with little or no modification and/or consumer input, there is considerable flexibility, adaptability, and opportunity for customization to meet the specific needs of various consumers under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols.

Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “activating”, “accessing”, “applying”, “analyzing”, “calculating”, “capturing”, “categorizing”, “classifying”, “comparing”, “defining”, “detecting”, “determining”, “distributing”, “encrypting”, “extracting”, “filtering”, “forwarding”, “generating”, “identifying”, “implementing”, “monitoring”, “obtaining”, “processing”, “providing”, “receiving”, “requesting”, “saving”, “sending”, “storing”, “transferring”, “transforming”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations.

In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet, or a cloud.

Therefore, numerous variations, whether explicitly provided for by the specification or implied by the specification or not, may be implemented by one of skill in the art in view of this disclosure.

What is claimed is:

1. A method for providing secure loan-based transactions comprising:
providing a secure transaction business loan program;
a borrower providing loan request information to the secure transaction business loan program;
analyzing the loan request information;
approving secure transaction business loan funds and providing a borrower account through the secure transaction business loan program;
associating the approved secure transaction business loan funds with the borrower account, the approved secure transaction business loan funds to be used by the secure transaction business loan program on behalf of the borrower to make approved purchases;
the borrower submitting a purchase request for the purchase of one or more products and/or services to the secure transaction business loan program;
analyzing the purchase request for the purchase of one or more products and/or services;
the secure transaction business loan program approving at least part of the purchase request and determining an approved merchant to provide the approved products and/or services that are the subject of the approved purchase request; and
the secure transaction business loan program executing a purchase transaction to obtain the approved products and/or services whereby the secure transaction business loan program transfers at least part of the approved secure transaction business loan funds from the borrower account to the approved merchant without providing the borrower direct access to the approved secure transaction business loan funds.

2. The method for providing secure loan-based transactions of claim 1, wherein;
the secure transaction business loan program is provided by one or more secure transaction business loan program providers selected from the group of secure transaction business loan program providers consisting of:
a government agency;
an international agency;
one or more charities/charitable organizations; and
a political organization.

3. The method for providing secure loan-based transactions of claim 1, wherein;
the secure transaction business loan program is implemented, at least in part, for the purpose of providing secure transaction business loans to borrowers who do not qualify for more traditional business loans.

4. The method for providing secure loan-based transactions of claim 1, wherein;
the secure transaction business loan program is implemented, at least in part, for the purpose of providing secure transaction business microloans as part of a microcredit system.

5. The method for providing secure loan-based transactions of claim 1, wherein;
the potential borrower provides the secure transaction business loan program the loan request information through a mobile computing system.

6. The method for providing secure loan-based transactions of claim 1, wherein;
the potential borrower provides the secure transaction business the loan program loan request information through a mobile phone using Short Message Service (SMS).

7. The method for providing secure loan-based transactions of claim 1, wherein;
analyzing the loan request information includes analyzing the type of business to be funded by the secure transaction business loan, the products and or services to be provided by the business to be funded by the secure transaction business loan, and the perceived contribution to the community by the business to be funded by the secure transaction loan.

8. The method for providing secure loan-based transactions of claim 1, wherein;
the purchase request includes one or more purchase request information selected from the group of purchase request information consisting of:
information indicating the products and/or services the borrower desires to purchase;
information indicating the estimated, or known, cost of the products and/or services the borrower desires to purchase;
information indicating the name, and/or location, of a given merchant from which the borrower desires to purchase the products and/or services;
information indicating a date, or date range, the borrower desires to purchase, and/or obtain, the desired products and/or services;
information indicating a time of day the borrower desires to purchase, and/or obtain, the desired products and/or services;
information indicating the location where the borrower desires to pick up, or take delivery of, the desired products and/or services once purchased.

9. The method for providing secure loan-based transactions of claim 1, wherein;
the potential borrower provides the secure transaction business loan program the purchase request through a mobile computing system.

10. The method for providing secure loan-based transactions of claim 1, wherein;
the potential borrower provides the secure transaction business the loan program purchase request through a mobile phone using Short Message Service (SMS).

11. The method for providing secure loan-based transactions of claim 1, wherein;
analyzing the purchase request for the purchase of one or more products and/or services includes determining if the one or more products and/or services are considered appropriate products and/or services by the secure transaction business loan program provider.

12. The method for providing secure loan-based transactions of claim 1, wherein;
analyzing the purchase request for the purchase of one or more products and/or services includes determining if a requested merchant to provide the one or more products and/or services is a pre-approved merchant in a merchant network associated with the secure transaction business loan program provider.

13. The method for providing secure loan-based transactions of claim 1, wherein;
analyzing the purchase request for the purchase of one or more products and/or services includes determining a balance of the approved secure transaction business loan funds in the borrower account and providing information indicating the balance of the approved secure transaction business loan funds to the borrower.

14. The method for providing secure loan-based transactions of claim 1, wherein;
analyzing the purchase request for the purchase of one or more products and/or services includes determining a projected balance of the approved secure transaction business loan funds in the borrower account and providing information indicating the projected balance of the approved secure transaction business loan funds to the borrower.

15. A system for providing secure loan-based transactions comprising:
a secure transaction business loan program implemented, at least in part, on one or more computing systems;
a borrower computing system; and
one or more processors associated with one or more computing systems, the one or more processors associated with one or more computing system implementing at least part of a process for providing secure loan-based transactions, the process for providing secure loan-based transactions including:
a borrower providing loan request data to the secure transaction business loan program through the borrower computing system;
the secure transaction business loan program using the one or more processors associated with one or more computing systems to analyze the loan request data;
secure transaction business loan funds being approved through the secure transaction business loan program and the secure transaction business loan program using the one or more processors associated with one or more computing systems to establish a borrower account;
the secure transaction business loan program using the one or more processors associated with one or more computing systems to associate the approved secure transaction business loan funds with borrower account, the approved secure transaction business loan funds to be used by the secure transaction business loan program on behalf of the borrower to make approved purchases;
the borrower submitting purchase request data for the purchase of one or more products and/or services to the secure transaction business loan program through the borrower computing system;
the secure transaction business loan program using the one or more processors associated with one or more computing systems to analyze the purchase request data for the purchase of one or more products and/or services;
at least one of the requested one or more products and/or services of the purchase request data for the purchase of one or more products and/or services being approved by the secure transaction business loan program and the secure transaction business loan program using the one or more processors associated with one or more computing systems to determine an approved merchant to provide the approved products and/or services that are the subject of the purchase request data for the purchase of one or more products and/or services; and
the secure transaction business loan program using the one or more processors associated with one or more computing systems to execute a purchase transaction to obtain the approved products and/or services that are the subject of the purchase request data for the purchase of one or more products and/or services whereby the secure transaction business loan program uses the one or more processors associated with one or more computing systems to transfer at least part of the approved secure transaction business loan funds from the borrower account to the approved merchant without providing the borrower direct access to the approved secure transaction business loan funds.

16. The system for providing secure loan-based transactions of claim 15, wherein;
the secure transaction business loan program is provided by one or more secure transaction business loan program providers selected from the group of secure transaction business loan program providers consisting of:
a government agency;
an international agency;
one or more charities/charitable organizations; and
a political organization.

17. The system for providing secure loan-based transactions of claim 15, wherein;
the secure transaction business loan program is implemented, at least in part, for the purpose of providing secure transaction business loans to borrowers who do not qualify for more traditional business loans.

18. The system for providing secure loan-based transactions of claim 15, wherein;
the secure transaction business loan program is implemented, at least in part, for the purpose of providing secure transaction business microloans as part of a microcredit system.

19. The system for providing secure loan-based transactions of claim 15, wherein;
the borrower provides the secure transaction business loan program the loan request data through a mobile computing system.

20. The system for providing secure loan-based transactions of claim 15, wherein;
the potential borrower provides the secure transaction business loan program the loan request data through a mobile phone using Short Message Service (SMS).

21. The system for providing secure loan-based transactions of claim 15, wherein;
analyzing the loan request data includes analyzing the type of business to be funded by the secure transaction business loan, the products and or services to be provided by the business to be funded by the secure transaction business loan, and the perceived contribution to the community by the business to be funded by the secure transaction loan.

22. The system for providing secure loan-based transactions of claim 15, wherein;
the purchase request data for the purchase of one or more products and/or services includes one or more purchase request data for the purchase of one or more products and/or services selected from the group of purchase request data for the purchase of one or more products and/or services consisting of:
data indicating the products and/or services the borrower desires to purchase;
data indicating the estimated, or known, cost of the products and/or services the borrower desires to purchase;
data indicating the name, and/or location, of a given merchant from which the borrower desires to purchase the products and/or services;
data indicating a date, or date range, the borrower desires to purchase, and/or obtain, the desired products and/or services;
data indicating a time of day the borrower desires to purchase, and/or obtain, the desired products and/or services;
data indicating the location where the borrower desires to pick up, or take delivery of, the desired products and/or services once purchased.

23. The system for providing secure loan-based transactions of claim 15, wherein;
the borrower provides the secure transaction business loan program the purchase request data for the purchase of one or more products and/or services through a mobile computing system.

24. The system for providing secure loan-based transactions of claim 15, wherein;
the borrower provides the secure transaction business loan program the purchase request data for the purchase of one or more products and/or services through a mobile phone using Short Message Service (SMS).

25. The system for providing secure loan-based transactions of claim 15, wherein;
analyzing the purchase request data for the purchase of one or more products and/or services includes determining if the one or more products and/or services are considered appropriate products and/or services by the secure transaction business loan program provider.

26. The system for providing secure loan-based transactions of claim 15, wherein;
analyzing the purchase request data for the purchase of one or more products and/or services includes determining if a requested merchant to provide the one or more products and/or services is a pre-approved merchant in a merchant network associated with the secure transaction business loan program provider.

27. The system for providing secure loan-based transactions of claim 15, wherein;
analyzing the purchase request data for the purchase of one or more products and/or services includes determining a balance of the approved secure transaction business loan funds in the borrower account and providing information indicating the balance of the approved secure transaction business loan funds to the borrower.

28. The system for providing secure loan-based transactions of claim 15, wherein;
analyzing the purchase request data for the purchase of one or more products and/or services includes determining a projected balance of the approved secure transaction business loan funds in the borrower account and providing information indicating the projected balance of the approved secure transaction business loan funds to the borrower.

29. A system for providing secure loan-based transactions comprising:
a secure transaction business loan program implemented, at least in part, on one or more computing systems;
a borrower computing system;
a pre-approved products database including data indicating products and/or services per-approved for purchase using secure transaction business loan funds;
a pre-approved merchants database including data indicating merchants per-approved to provide products and/or services purchased using secure transaction business loan funds;
a product price database including data indicating market prices for one or more products and/or services; and
one or more processors associated with one or more computing systems, the one or more processors associated with one or more computing system implementing at least part of a process for providing secure loan-based transactions, the process for providing secure loan-based transactions including:
a borrower providing loan request data to the secure transaction business loan program through the borrower computing system;
the secure transaction business loan program using the one or more processors associated with one or more computing systems to analyze the loan request data;
secure transaction business loan funds being approved through the secure transaction business loan program and the secure transaction business loan program using the one or more processors associated with one or more computing systems to establish a borrower account;
the secure transaction business loan program using the one or more processors associated with one or more computing systems to associate the approved secure transaction business loan funds with borrower account, the approved secure transaction business loan funds to be used by the secure transaction business loan program on behalf of the borrower to make approved purchases;
the borrower submitting purchase request data for the purchase of one or more products and/or services to the secure transaction business loan program through the borrower computing system;
the secure transaction business loan program using the one or more processors associated with one or more computing systems to analyze the purchase request data for the purchase of one or more products and/or services and the pre-approved products database to determine if the one or more products and/or services of purchase request data includes products and/or services per-approved for purchase using secure transaction business loan funds;
the secure transaction business loan program using the one or more processors associated with one or more computing systems to analyze the purchase request data for the purchase of one or more products and/or services and the product price database to determine a market price for one or more products and/or services that are the subject of the purchase request data for the purchase of one or more products and/or services;
the secure transaction business loan program using the one or more processors associated with one or more computing systems to determine if the borrow account includes enough secure transaction business loan funds to purchase the one or more products and/or services that are the subject of the purchase request data for the purchase of one or more products and/or services based on the determined market price for one or more products and/or services that are the subject of the purchase request data for the purchase of one or more products and/or services;
at least one of the requested one or more products and/or services of the purchase request data for the purchase of one or more products and/or services being approved by the secure transaction business loan program;
the secure transaction business loan program using the one or more processors associated with one or more computing systems to analyze the purchase request data for the purchase of one or more products and/or services and the pre-approved merchants database to designate a pre-approved merchant to provide the approved products and/or services that are the subject of the purchase request data for the purchase of one or more products; and
the secure transaction business loan program using the one or more processors associated with one or more computing systems to execute a purchase transaction to obtain the approved products and/or services that are the subject of the purchase request data for the purchase of one or more products and/or services whereby the secure transaction business loan program uses the one or more processors associated with one or more computing systems to transfer at least part of the approved secure transaction business loan funds from the borrower account to the approved merchant without providing the borrower direct access to the approved secure transaction business loan funds.

30. The system for providing secure loan-based transactions of claim 29, wherein;
the secure transaction business loan program is provided by one or more secure transaction business loan program providers selected from the group of secure transaction business loan program providers consisting of:
a government agency;
an international agency;
one or more charities/charitable organizations; and
a political organization.

31. The system for providing secure loan-based transactions of claim 29, wherein;
the secure transaction business loan program is implemented, at least in part, for the purpose of providing secure transaction business loans to borrowers who do not qualify for more traditional business loans.

32. The system for providing secure loan-based transactions of claim 29, wherein;
the secure transaction business loan program is implemented, at least in part, for the purpose of providing secure transaction business microloans as part of a microcredit system.

33. The system for providing secure loan-based transactions of claim 29, wherein;
the borrower provides the secure transaction business loan program the loan request data through a mobile computing system.

34. The system for providing secure loan-based transactions of claim 29, wherein;
the potential borrower provides the secure transaction business loan program the loan request data through a mobile phone using Short Message Service (SMS).

35. The system for providing secure loan-based transactions of claim 29, wherein;
analyzing the loan request data includes analyzing the type of business to be funded by the secure transaction business loan, the products and or services to be provided by the business to be funded by the secure transaction business loan, and the perceived contribution to the community by the business to be funded by the secure transaction loan.

36. The system for providing secure loan-based transactions of claim 29, wherein;
the purchase request data for the purchase of one or more products and/or services includes one or more purchase request data for the purchase of one or more products and/or services selected from the group of purchase request data for the purchase of one or more products and/or services consisting of:
data indicating the products and/or services the borrower desires to purchase;
data indicating the estimated, or known, cost of the products and/or services the borrower desires to purchase;
data indicating the name, and/or location, of a given merchant from which the borrower desires to purchase the products and/or services;
data indicating a date, or date range, the borrower desires to purchase, and/or obtain, the desired products and/or services;
data indicating a time of day the borrower desires to purchase, and/or obtain, the desired products and/or services;
data indicating the location where the borrower desires to pick up, or take delivery of, the desired products and/or services once purchased.

37. The system for providing secure loan-based transactions of claim 29, wherein;
the borrower provides the secure transaction business loan program the purchase request data for the purchase of one or more products and/or services through a mobile computing system.

38. The system for providing secure loan-based transactions of claim 29, wherein;
the borrower provides the secure transaction business loan program the purchase request data for the purchase of one or more products and/or services through a mobile phone using Short Message Service (SMS).
